(19) United States
(12) Patent Application Publication
(10) Pub. No.: US 2013/0293128 A1
(43) Pub. Date: Nov. 7, 2013

(54) LIGHT FIXTURE

(71) Applicants: Michael Youssef, Mississauga (CA); Lech Adamin, Amherstview (CA); Santo Beltrocco, Kingston (CA)

(72) Inventors: Michael Youssef, Mississauga (CA); Lech Adamin, Amherstview (CA); Santo Beltrocco, Kingston (CA)

(73) Assignee: BOMBARDIER TRANSPORTATION GMBH, Berlin (DE)

(21) Appl. No.: 13/809,721

(22) PCT Filed: Jul. 14, 2010
(86) PCT No.: PCT/CA2010/001107

§ 371 Date: Apr. 18, 2013

(51) Int. Cl. F21V 23/06

(52) U.S. Cl. CPC F21V 23/06
USPC 315/193; 315/322

(57) ABSTRACT

A light fixture comprising a light emitting device, a first electrical path suitable for connecting the light emitting device to a first power circuit, a second electrical path suitable for connecting the light emitting device to a second power circuit and a connector element for acquiring a selected one of a first configuration and a second configuration. Wherein in the first configuration, the light emitting device is in electrical communication with the first electrical path for being powered by the first power circuit and in the second configuration, the light emitting device is in electrical communication with the second electrical path for being powered by the second power circuit.

### FIELD OF THE INVENTION

The present invention relates generally to the field of light fixtures, and more particularly to light fixtures that are able to be connected together in series to transfer electricity from two different power sources through a given light fixture to other light fixtures connected thereto.

### BACKGROUND

For safety and security reasons, lighting systems that are used in many public places, such as within public buildings and public transit vehicles, often require the presence of both normal operation lighting (that provides light under normal operating conditions) and emergency operation lighting (that provides light under emergency conditions and optionally under standby conditions as well). In order to be able to provide light under both of these operating conditions, the presence of different light fixtures connected to different power circuits is required; namely normal operation light fixtures that are connected to a normal operation power circuit and emergency light fixtures that are connected to an emergency power circuit. The emergency power circuit is operative for providing light to emergency light fixtures that are generally situated in areas such as above doorways, within stairwells and along floor paths, among other possibilities.

In order to have both normal operation light fixtures and emergency light fixtures connected respectively to different power circuits, a significant amount of wiring is required. This wiring adds additional cost and additional complexity to the installation of the light fixtures within a building or transit vehicle. In addition, the requirement for different light fixtures creates an increase in the parts count required for the construction and fit-up of a building or transit vehicle.

Against this background, it may be seen that there is a need in the industry to provide a lighting system, and specifically a light fixture, that alleviates, at least in part, the deficiencies with existing redundant lighting systems.

### SUMMARY OF THE INVENTION

In accordance with a first broad aspect, the present invention provides a light fixture comprising a light emitting device, a first electrical path suitable for connecting the light emitting device to a first power circuit, a second electrical path suitable for connecting the light emitting device to a second power circuit and a connector element for acquiring a selected one of a first configuration and a second configuration. Wherein in the first configuration, the light emitting device is in electrical communication with the first electrical path for being powered by the first power circuit and in the second configuration, the light emitting device is in electrical communication with the second electrical path for being powered by the second power circuit.

In accordance with a second broad aspect, the present invention provides a light fixture comprising a first electrical path for connection to a first power source, a second electrical path for connection to a second power source and a light emitting device connected to a single one of the first electrical path and the second electrical path for being powered by a single one of the first power source and the second power source. The light fixture is electrically connectable to a second light fixture for transferring power from both the first power source and the second power source to the second light fixture.

In accordance with a third broad aspect, the present invention provides a light system comprising a first set of light fixtures and a second set of light fixtures electrically connected together in series. Each light fixture in the first set of light fixtures comprises a respective light emitting device, with each light emitting device being connected to a first power circuit. Each light fixture in the second set of light fixtures comprises a respective light emitting device, with each light emitting device being connected to a second power circuit. During a first operating condition, electricity is provided to both the first set of light emitting devices and the second set of light emitting devices, and wherein during a second operating condition, electricity is provided only to the second set of light emitting devices.

In accordance with a fourth broad aspect, the present invention provides a light fixture assembly, comprising a plurality of light fixtures. Each light fixture comprises a light emitting device, a first electrical path suitable for connecting the light emitting device to a first power circuit, a second electrical path suitable for connecting the light emitting device to a second power circuit and a connector element for connecting the light emitting device to a selected one of the first electrical path and the second electrical path. Each light fixture is adapted to transfer electricity from the first power circuit and the second power circuit to at least two other light fixtures within the light fixture assembly.

In accordance with a fifth broad aspect, the present invention provides a light fixture comprising a first electrical path for connection to a first electrical circuit, the first electrical path commencing at a first electrical contact and terminating at a second electrical contact, a second electrical path for connection to a second electrical circuit, the second electrical path commencing at a third electrical contact and terminating at a fourth electrical contact and a light emitting device in electrical communication with a single one of the first electrical path and the second electrical path for being powered by a single one of the first electrical circuit and the second electrical circuit.

These and other aspects and features of the present invention will now become apparent to those of ordinary skill in the art upon review of the following description of specific embodiments of the invention in conjunction with the accompanying drawings.

### BRIEF DESCRIPTION OF THE DRAWINGS

In the accompanying drawings:

FIG. 1 shows a non-limiting representation of electrical connections within a light fixture according to a first embodiment of the present invention, with an electrical connector element shown in a first configuration;

FIG. 2 shows a non-limiting representation of the light fixture of FIG. 1, with the electrical connector element shown in a second configuration;

FIG. 3 shows a non-limiting representation of electrical connections within a light fixture according to a second embodiment of the present invention, with an electrical connector element shown in a first configuration;

FIG. 4 shows a non-limiting representation of the light fixture of FIG. 3, with the electrical connector element shown in a second configuration;

FIG. 5 shows a non-limiting representation of a plurality of the light fixtures of FIG. 3 connected together in series, with some of the electrical connector elements shown in the first configuration and one electrical connector element shown in the second configuration;

FIG. 6 shows a non-limiting representation of a plurality of light fixtures according to a third embodiment of the present invention that are connected together in series in a tile-like manner, with some of the electrical connector elements shown in a first configuration and some electrical connector elements shown in a second configuration; and

FIG. 7 shows a non-limiting representation of electrical connections within a light fixture according to a third embodiment of the present invention, wherein the return paths are located exterior to the light fixture.

It is to be expressly understood that the description and drawings are only for the purpose of illustration of certain embodiments of the invention and are an aid for understanding. They are not intended to be a definition of the limits of the invention

### DETAILED DESCRIPTION

To facilitate the description, any reference numerals designating an element in one figure will designate the same element if used in any other figures. In describing the embodiments, specific terminology is resorted to for the sake of clarity but the invention is not intended to be limited to the specific terms so selected, and it is understood that each specific term comprises all equivalents.

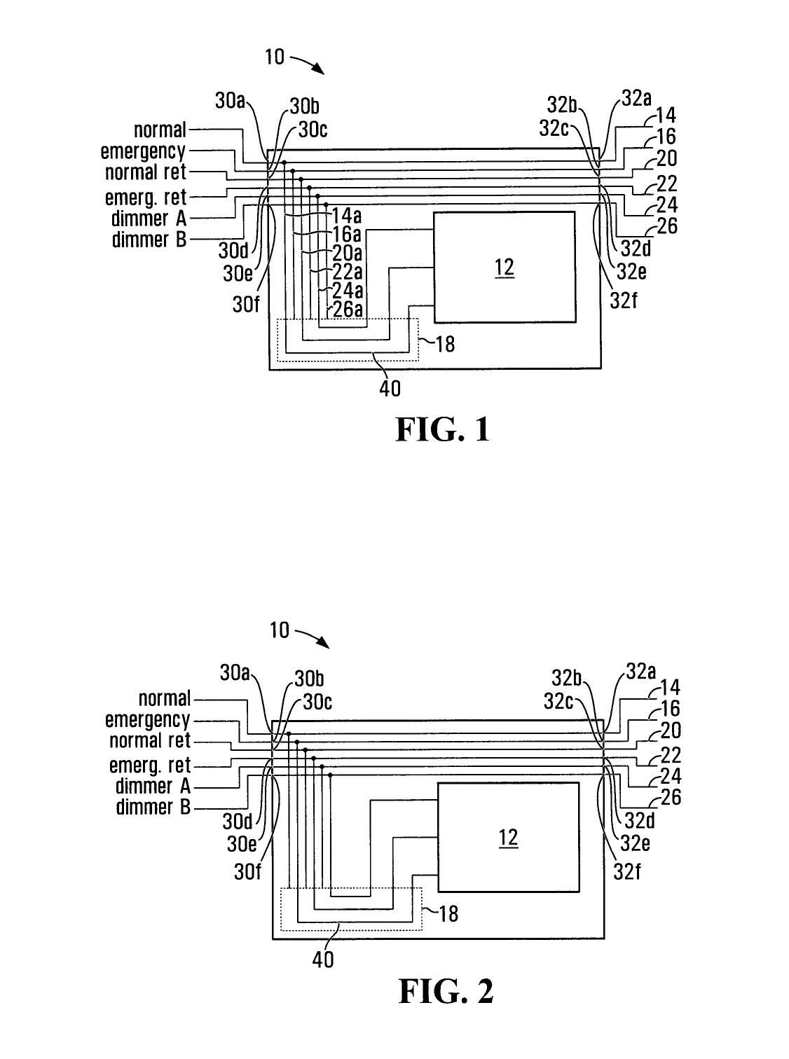

Shown in FIG. 1 is an electrical representation of a light fixture 10 in accordance with a first non-limiting example of the present invention that is suitable for being connected to both a normal operation power circuit and an emergency power circuit. The light fixture 10 is thus suitable for use in an environment that requires a redundant emergency power circuit such as a public building or a public transit vehicle, such as a bus, railway train and/or monorail vehicle.

As will be described in more detail throughout the present description, the light fixture 10 according to the present invention is operative for being connected in series to one or more other light fixtures 10, so as to be able to transfer power from both a normal operation power source and an emergency power source to the other light fixtures 10 to which it is connected.

In the non-limiting embodiment shown in FIG. 1, the light fixture 10 comprises a light emitting device 12 for emitting light when in electrical communication with either the normal operation power source or the emergency power source. The light emitting device 12 can be any type of light emitting device, such as a compact fluorescent lamp (CFL), an incandescent light, a fluorescent light or one or more light emitting diode (LED) lights, among other possibilities.

The light fixture 10 further comprises a first electrical path 14, a second electrical path 16, a first return path 20, a second return path 22, a first dimmer path 24 and a second dimmer path 26, each of which will be described in more detail below.

The first electrical path 14 is operative for connecting the light fixture 10 to a first power circuit, which will be referred to herein as the normal operation power circuit. The second electrical path 16 is operative for connecting the light fixture 10 to a second power circuit, which will be referred to herein as the emergency operation power circuit. As used herein, the term electrical path refers to a conductive path that allows an electrical current to flow therethrough.

The normal operation power circuit receives power from a normal operation power source and the emergency operation power circuit receives power from an emergency operation power source. As will be described in more detail below, the light emitting device 12 is suitable for being placed into electrical communication with a single one of the first electrical path 14 or the second electrical path 16, such that the light emitting device 12 is powered by one of the normal operation power source or the emergency operation power source.

As will be described in more detail below, in a normal operating condition, both the normal operation power source and the emergency operation power source provide electricity to the light fixture 10. However, in an emergency or standby operating condition, only the emergency operation power source provides electricity to the light fixture 10. By using only one power source, instead of two power sources, power consumption can be reduced when in an emergency or standby condition.

In general, during normal operating conditions, both the normal operation lighting circuit and the emergency operation lighting circuit are operational, such that both light fixtures connected to the normal operation power source and the emergency operation power source provide light. However, during emergency operating conditions, in order to reduce power consumption only the emergency lighting circuit is operational, such that only the light fixtures that are connected to the emergency operation lighting circuit provide light. Alternatively, the normal operation lighting circuit can be “on” during normal operating conditions and the emergency lighting circuit can be “off” during normal operating conditions. In such a circumstance, when in normal operating conditions, no light is provided by the emergency light fixtures. As such, only the emergency lighting circuit is “on” during emergency operating conditions, during which time the normal operation lighting circuit is “off”.

Referring back to FIGS. 1 and 2, the first return path 20 corresponds to the first electrical path 14 for creating a closed loop circuit with the normal operation power source. The second return path 22 corresponds to the second electrical path 16 for creating a closed loop circuit with the emergency operation power source. As such, the first electrical path 14 and the first return path 20 form part of the normal operation power circuit and the second electrical path 16 and the second return path 22 form part of the emergency operation power circuit. In the embodiment shown in FIGS. 1 and 2, the first and second return paths 20, 22, are incorporated into the light fixture 10 itself.

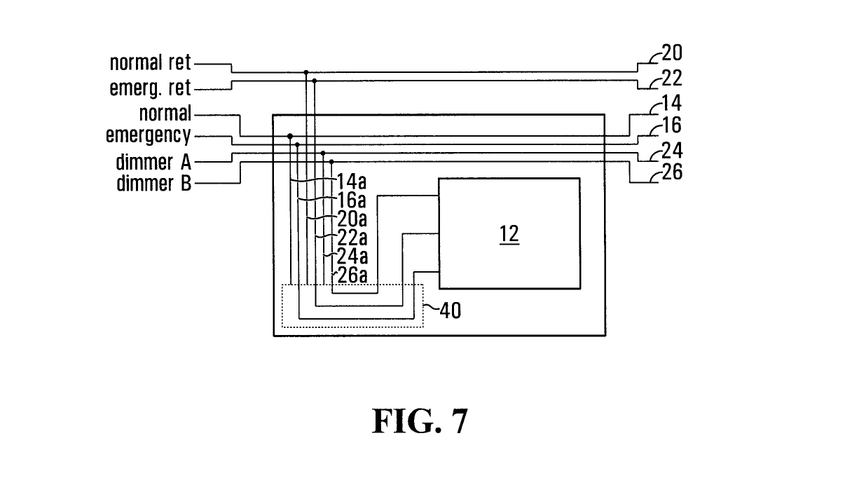

In an alternative non-limiting embodiment shown in FIG. 7, the return paths 20, 22 can be located external to the light fixture 10. For example, the return paths 20, 22 may be included within the infrastructure of the transit vehicle during manufacture, such that during installation of one or more light fixtures 10, the light fixtures would need to be connected to the external return paths 20, 22. This may be done by connecting a light fixture 10 to sockets that would connect the relevant wiring within the light fixture 10 to the external return paths 20, 22. The different manners that a light fixture, such as that shown in FIG. 7, could be connected to externally located return paths 20, 22 would be known to a person of skill in the art, and as such will not be described in more detail herein.

The first dimmer path 24 and the second dimmer path 26 are suitable for carrying dimming controls to the light emitting device 12, and to other light fixtures that are connected in series to the light fixture 10. As will be described in more detail below, the light emitting device 12 is suitable for being connected to a single one of the first dimmer path 24 and the second dimmer path 26. In general, the first dimmer path 24 is associated with the first electrical path 14, such that dimming controls that are transmitted through the first dimmer path 24 are intended to control light emitting devices 12 that are in electrical communication with the normal operation power circuit. Likewise, the second dimmer path 26 is associated with the second electrical path 16, such that dimming controls that are sent along the second dimmer path 26 are intended to control light emitting devices 12 that are in electrical communication with the emergency power circuit.

The first electrical path 14, the second electrical path 16, the first return path 20, the second return path 22, the first dimmer path 24 and the second dimmer path 26 each commence at a first electrical contact 30a-f respectively, and terminate at a second electrical contact 32a-f respectively. As such, when a first light fixture 10 and a second light fixture 10 are placed in contact with each other, the terminating electrical contacts 32a-f of the first light fixture 10 are placed in contact with the commencing electrical contacts 30a-f of the second light fixture 10. In this manner, a plurality of light fixtures can be attached in series, such that during normal operation, electricity from both a normal operation power source and an emergency operation power source are transferred through the light fixture 10 to other light fixtures attached thereto.

The contact between the terminating electrical contacts 32a-f of one light fixture and the commencing electrical contacts 30a-f of another light fixture may be in direct communication with each other, meaning that the terminating electrical contacts 32a-f of one light fixture physically touch the commencing electrical contacts 30a-f of the other light fixture. Alternatively, the terminating electrical contacts 32a-f of one light fixture may be connected to the commencing electrical contacts 30a-f of another light fixture via a pigtail connector, or other type of wire connectors known in the art. Any manner of electrically connecting in series the terminating electrical contacts 32a-f of one light fixture 10 to the commencing electrical contact 30a-f of another light fixture 10 is possible, without departing from the scope of the invention.

Extending from each of the first electrical path 14, the second electrical path 16, the first return path 20, the second return path 22, the first dimmer path 24 and the second dimmer path 26 is a respective tapped-off path 14a, 16a, 20a, 22a, 24a and 26a. The tapped-off paths 14a, 16a, 20a, 22a, 24a and 26a extend towards the light emitting device 12, so as to be able to put at least some of the paths 14, 16, 20, 22, 24 and 26 in communication with the light emitting device 12. However, as shown in FIGS. 1 and 2, the tapped-off paths 14a, 16a, 20a, 22a, 24a and 26a do not connect directly to the light emitting device 12, and instead include a break that needs to be bridged in order to place the light emitting device 12 in electrical communication with at least one of paths 14, 16, 20, 22, 24 and 26.

As shown in FIG. 1, the light fixture 10 comprises a connector element 18 that is suitable for bridging the break between the paths 14a, 16a, 20a, 22a, 24a and 26a and the light emitting device 12. As such, the connector element 18 is able to place the light emitting device 12 into electrical communication with a single one of the first electrical path 14 or the second electrical path 16. More specifically, the connector element 18 is capable of acquiring a selected one of a first configuration and a second configuration for placing the light emitting device 12 in electrical communication with a selected one of the first electrical path 14 or the second electrical path 16. When the connector element 18 is in the first configuration (as shown in FIG. 1), the light emitting device 12 is placed in electrical communication with the first electrical path 14, via tapped off path 14a, such that the light emitting device 12 is connected to the normal operation power circuit for receiving power from the normal operation power source. When the connector element 18 is in the second configuration (as shown in FIG. 2), the light emitting device 12 is placed in electrical communication with the second electrical path 16, via the tapped off path 16a, such that the light emitting device 12 is connected to the emergency power circuit for receiving power from the emergency power source.

During the installation of the light fixture into its environment, the person installing the light fixture 10 configures the connector element 18 such that it acquires a selected one of the first configuration or the second configuration. In this manner, depending on how the connector element 18 is configured, the light fixture 10 is suitable for being used either as a normal operation light fixture that is powered by the normal operation power source, or an emergency light fixture that is powered by the emergency operation power source. By using the same light fixture for both normal operation lighting applications and emergency operation lighting applications, a reduced part count can be achieved when constructing a building or a transit vehicle.

The connector element 18 that acquires a selected one of the first configuration or the second configuration, for placing the light emitting device 12 in electrical communication with a single one of the normal operation electrical path 14 or the emergency operation electrical path 16, can be any suitable connector element known in the art.

In the non-limiting example of implementation shown in FIGS. 1 and 2, the connector element 18 is in the form of a jumper connector 40. The jumper connector 40 is able to close a break or bypass in the electrical circuit between one of the tapped-off paths 14a and 16a, and the light emitting device 12.

As shown in FIG. 1, the jumper connector 40 is in the first configuration, wherein it completes an electrical connection between the first electrical path 14, via the tapped-off path 14a, and the light emitting device 12. The jumper connector 40 further completes the connection between the first return path 20, via the tapped-off path 20a, and the light emitting device 12, and the connection between the first dimmer path 24, via the tapped-off path 24a, and the light emitting device 12. In this manner, the jumper connector 40 connects light emitting device 12 to the normal operation power circuit for being powered by the normal operation power source. The jumper connector 40 further connects the light emitting device 12 to the first dimmer path 24, such that the light emitting device 12 is controlled via dimming controls that are passed through the first dimmer path 24.

The jumper connector 40 is a configurable connector that can be caused to acquire at least two different configurations by a user. As such, at the time of installation of the light fixture 10, a user can configure the jumper connector 40 such that it is either in the configuration shown in FIG. 1, or such that it is in a different configuration, such as that shown in FIG. 2.

More specifically, in FIG. 2, the jumper connector 40 is shown in the second configuration, wherein it completes a connection between the second electrical path 16, via the tapped-off path 16a, and the light emitting device 12. The jumper connector 40 further completes the connection between the second return path 22, via tapped-off path 22a and the light emitting device 12, and a connection between the second dimmer path 26, via tapped-off path 26a and the light emitting device 12. In this manner the, the jumper connector 40 connects light emitting device 12 to the emergency operation power circuit for being powered by the emergency operation power source. The jumper connector 40 further connects the light emitting device 12 to the second dimmer path 26 such that the light emitting device 12 is able to be controlled via dimming controls that are passed through the second dimmer path 26.

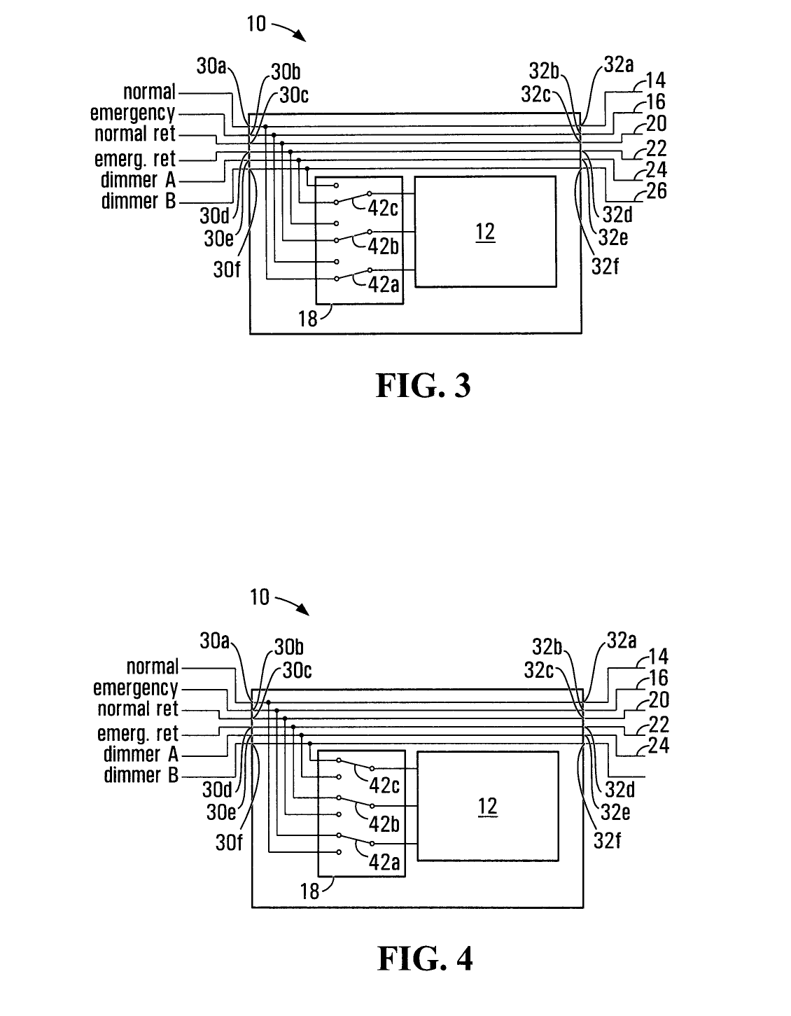

In an alternative, non-limiting example of implementation shown in FIGS. 3 and 4, the connector element 18 is in the form of three electrical switches 42a, 42b and 42c. The electrical switches 42a, 42b and 42c are suitable for bridging the break between one of the paths 14a and 16a and the light emitting device 12, one of the paths 20a and 22a and the light emitting device 12, and one of the paths 24a and 26a and the light emitting device 12. It should be appreciated that the three electrical switches 42a, 42b and 42c may be interconnected such that they function as a single electrical switch, wherein they all switch position simultaneously. Alternatively, the three electrical switches 42a, 42b and 42c may be independently configurable, such that each switch can change position independently of the other switches.

As shown in FIG. 3, the three electrical switches 42a, 42b and 42c are in the first configuration, wherein electrical switch 42a completes an electrical connection between the first electrical path 14 and the light emitting device 12, switch 42b completes an electrical connection between the first return path 20 and the light emitting device 12, and switch 42c completes an electrical connection between the first dimmer path 24 and the light emitting device 12. In this manner, the light emitting device 12 is in electrical communication with the normal operation power circuit for being powered by the normal operation power source. Switch 42c further connects the light emitting device 12 to the first dimmer path 24 such that the light emitting device 12 is controlled via dimming controls that are passed through the first dimmer path 24.

At the time of installation of the light fixture 10, a user can configure the electrical switches 42a, 42b and 42c such that they are either in the configuration shown in FIG. 1, or such that they are in a different configuration, such as that shown in FIG. 2.

More specifically, in FIG. 2, the electrical switches 42a, 42b and 42c are shown in a second configuration, wherein electrical switch 42a completes an electrical connection between the second electrical path 16 and the light emitting device 12, switch 42b completes an electrical connection between the second return path 22 and the light emitting device 12, and switch 42c completes an electrical connection between the second dimmer path 26 and the light emitting device 12. In this manner, the light emitting device 12 is in electrical communication with the emergency operation power circuit for being powered by the emergency operation power source. The light emitting device 12 is further in communication with the second dimmer path 26 such that the light emitting device 12 is controlled via dimming controls that are passed through the second dimmer path 26.

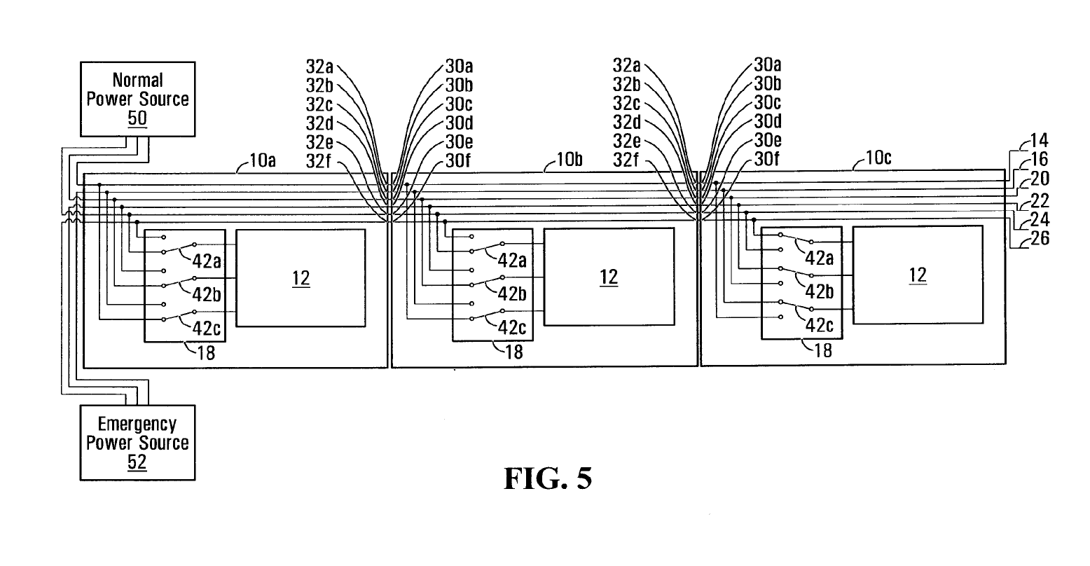

The manner in which the light fixture 10 functions during operation will now be described in more detail with respect to FIG. 5, wherein three light fixtures, which have been numbered 10a, 10b and 10c in order to avoid confusion, have been connected together in series. As shown, the terminating electrical contacts 32a-f of light fixture 10a have been connected to the commencing electrical contacts 30a-f of light fixture 10b and the terminating electrical contacts 32a-f of light fixture 10b have been connected to the commencing electrical contacts 30a-f of light fixture 10c.

Furthermore, the commencing electrical contacts 30a, 30c and 30e of light fixture 10a have been connected to a normal operation power source 50 and the commencing electrical contacts 30b, 30d and 30f of light fixture 10a have been connected to an emergency operation power source 52. Given that the light fixtures 10a, 10b and 10c have been connected together in series, electricity from the normal operation power source 50 passes through each of the light fixtures 10a, 10b and 10c along the electrical paths 14, 20 of the first power circuit. In addition, electricity from the emergency power source 52 passes through each of the light fixtures 10a, 10b and 10c along the electrical paths 16, 22 of the second power circuit.

As mentioned above, the first power circuit is a normal operation power circuit that provides power during normal operating conditions, and the second power circuit is an emergency power circuit that generally provides power during both normal operating conditions and emergency operating conditions.

In the non-limiting embodiment shown in FIG. 5, the light emitting devices 12 of light fixtures 10a and 10b are in electrical communication with the first electrical paths 14 of their respective light fixtures 10a and 10b. As such, these light fixtures are in communication with the normal operation power circuit and receive power from the normal operation power source 50. The light emitting device 12 of light fixture 10c is in electrical communication with the second electrical path 16 of light fixture 10c, such that it is in communication with the emergency operation power circuit and receives power from the emergency operation power source 52.

As such, during normal operation, when both the normal operation power source 50 and the emergency power source 52 are operational, the light emitting devices 12 of all of light fixtures 10a, 10b and 10c emit light. However, when faced with an emergency or standby situation, the normal operation power source 50 may be shut down, or be otherwise out of operation. In such a circumstance, only the light emitting devices that are in electrical communication with the emergency power circuit for receiving power from the emergency power source 52 would emit light. In the embodiment shown, only the light emitting device 12 of light fixture 10c would continue to emit light when in an emergency situation or standby condition, since this is the only light emitting device 12 that is in communication with the emergency power circuit. In such a situation, regardless of the fact that the light emitting devices 12 of light fixtures 10a, 10b would not emit light, the light fixtures 10a, 10b continue to transfer power from the emergency power source over their second electrical paths 16 to the light fixture 10c, since the electrical paths 16 of the three light fixtures 10a, 10b and 10c are connected in series.

The first and second dimmer paths 24 and 26 of the light fixtures 10a, 10b and 10c are also connected together in series. In this manner, by adjusting a dimming control at the first dimmer path 24 of one of the light fixtures, the dimming control for all of the light emitting devices 12 connected to the first dimmer path 24 is adjusted. Likewise, by adjusting a dimming control via the second dimmer path 26 at one of the light fixtures, the dimming control for all of the light emitting devices 12 connected to the second dimmer path is adjusted. This provides an easier, more time-efficient manner of controlling the dimming settings.

The light fixtures 10 as shown in FIGS. 1-5 each include one set of commencing electrical contacts 30a-f and one set of terminating electrical contacts 32a-f. As such, each light fixture 10 can be connected to two other light fixtures 10, with one light fixture connected to the commencing electrical contact 30a-f and another light fixture connected to the terminating electrical contacts 32a-f.

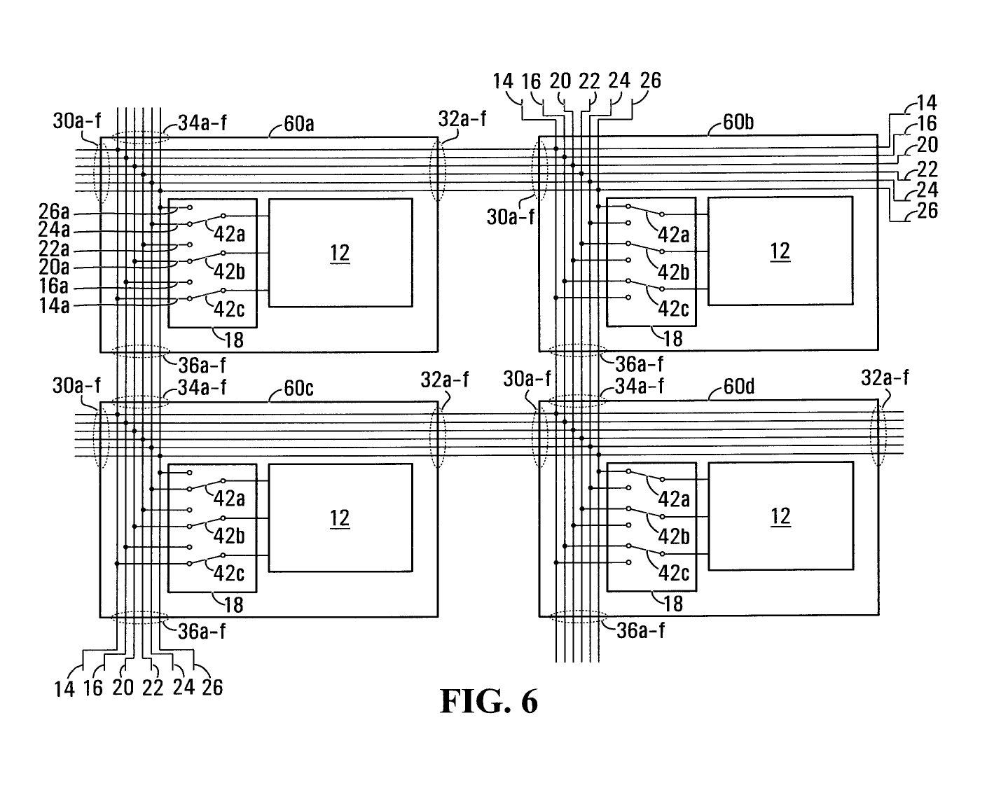

Shown in FIG. 6 are four light fixtures 60a, 60b, 60c and 60d in accordance with an alternative embodiment of the present invention, that are each capable of being connected to four other light fixtures. Light fixtures 60a, 60b, 60c and 60d can thus be arranged in a tillable configuration.

In the same manner as described above, each of the four light fixtures 60a, 60b, 60c and 60d comprises a light emitting device 12 and a connector element 18. In the non-limiting embodiment shown, the connector element 18 is in the form of three switches 42a, 42b and 42c, as previously described above.

Each of the light fixtures 60a, 60b, 60c and 60d includes a first set of commencing electrical contacts 30a-f and a second set of commencing electrical contacts 34a-f. In addition, each of the light fixtures 60a, 60b, 60c and 60d includes a first set of terminating electrical contacts 32a-f and a second set of terminating electrical contacts 36a-f. Between the first set of commencing electrical contacts 30a-f and the first set of terminating electrical contacts 32a-f is a first set of electrical paths that includes paths 14, 16, 20, 22, 24 and 26, as described above. Furthermore, between the second set of commencing electrical contacts 34a-f and the second set of terminating electrical contacts 36a-f is a second set of electrical paths that also includes paths 14, 16, 20, 22, 24 and 26, as described above.

Extending from one of the sets of electrical paths are the tapped-off paths 14a, 16a, 20a, 22a, 24a and 26a that extend towards the light emitting device 12, so as to be able to put at least some of the paths 14, 16, 20, 22, 24 and 26 in communication with the light emitting device 12. In the embodiment shown, the tapped-off paths 14a, 16a, 20a, 22a, 24a and 26a extend from the second set of electrical paths, between the second set of commencing electrical contacts 34a-f and the second set of terminating electrical contacts 36a-f.

Although not shown in the Figures, the first electrical paths 14 and the first return paths 20 are in electrical communication with a normal operation power source. In addition, the second electrical paths 16 and the second return paths 22 are in electrical communication with an emergency operation power source. As such, the light emitting devices of light fixtures 60a and 60c receive power from the normal operation power source, and light fixtures 60b and 60d receive power from the emergency operation power source. In this manner, under normal operating conditions, all of the light fixtures 60a, 60b, 60c and 60d emit light. However, under emergency operating conditions, only light fixtures 60b and 60d that are in electrical communication with the emergency operation power source emit light. In such a situation, regardless of the fact that the light emitting devices 12 of light fixtures 60a, 60c would not emit light, the light fixtures 60a, 60c continue to transfer power from the emergency operation power source to the light fixtures 60b and 60d, since all the electrical paths 16 are connected in series.

In accordance with a non-limiting example of implementation, an environment that is intended to receive light fixtures, such as the light fixtures 10 and 60 described in detail above, may be constructed in order to include internal wiring that facilitates the connection of the light fixtures 10 and/or 60 in series. For example, if the light fixtures 10 will be spaced 2 ft apart when installed within the ceiling of a public transit vehicle (such as a railway or monorail vehicle), it is possible that the transit vehicle is constructed in order to include wiring that can bridge that 2 ft distance between the two light fixtures 10.

While specific embodiments of the present invention have been described and illustrated, it will be apparent to those skilled in the art that numerous modifications and variations may be made without departing from the scope of the invention as defined in the appended claims.

What is claimed is:

1. A light fixture comprising:
a. a light emitting device;
b. a first electrical path suitable for connecting the light emitting device to a first power circuit;
c. a second electrical path suitable for connecting the light emitting device to a second power circuit;
d. a connector element for acquiring a selected one of:
i. a first configuration wherein the light emitting device is in electrical communication with the first electrical path for being powered by the first power circuit; and
ii. a second configuration wherein the light emitting device is in electrical communication with the second electrical path for being powered by the second power circuit.

2. A light fixture as defined in claim 1, wherein the first power circuit is a normal operation power circuit for a transit vehicle.

3. A light fixture as defined in claim 2, wherein the second power circuit is an emergency power circuit for a transit vehicle.

4. A light fixture as defined in claim 1, wherein the first electrical path is associated with a corresponding first electrical return path.

5. A light fixture as defined in claim 4, wherein the second electrical path is associated with a corresponding second electrical return path.

6. The light fixture as defined in claim 1, wherein the light emitting device comprises at least one light emitting diode (LED).

7. The light fixture as defined in claim 1, wherein the light emitting device comprises at least one incandescent light bulb.

8. The light fixture as defined in claim 1, wherein the connector element comprises a switch for acquiring a selected one of the first configuration and the second configuration.

9. The light fixture as defined in claim 1, wherein the connector element comprises an electrical jumper that is suitable for being configured into a selected one of the first configuration and the second configuration.

10. The light fixture as defined in claim 1, wherein the first electrical path and the second electrical path each comprise a first electrical contact and a second electrical contact, the first electrical path and the second electrical path each transmitting power from the first electrical contact to the second electrical contact, regardless of whether the connector element has acquired the first configuration or the second configuration.

11. The light fixture as defined in claim 1, further comprising:
a. a first dimmer path; and
b. a second dimmer path
wherein the light emitting device is in electrical communication with at least one of the first dimmer path and the second dimmer path.

12. The light fixture as defined in claim 11, wherein the connector element is a first connector element, the light fixture further comprising a second connector element for acquiring a selected one of:
i. a first configuration wherein the light emitting device is in electrical communication with the first dimmer path; and
ii. a second configuration wherein the light emitting device is in electrical communication with the second dimmer path.

13. A light fixture comprising:
a. a first electrical path for connection to a first power source;
b. a second electrical path for connection to a second power source;
c. a light emitting device connected to a single one of the first electrical path and the second electrical path for being powered by a single one of the first power source and the second power source;
the light fixture being electrically connectable to a second light fixture for transferring power from both the first power source and the second power source to the second light fixture.

14. A light fixture as defined in claim 13, wherein the first power source is a normal operation power source for a transit vehicle.

15. A light fixture as defined in claim 14, wherein the second power source is an emergency power source for a transit vehicle.

16. A light fixture as defined in claim 13, wherein the first electrical path is associated with a corresponding first electrical return path.

17. A light fixture as defined in claim 16, wherein the second electrical path is associated with a corresponding second electrical return path.

18. The light fixture as defined in claim 13, wherein the light emitting device comprises at least one light emitting diode (LED).

19. The light fixture as defined in claim 13, wherein the light emitting device comprises at least one incandescent light bulb.

20. The light fixture as defined in claim 13, further comprising a connector element for acquiring a selected one of:
a. a first configuration, wherein the light emitting device is connected to the first electrical path for being powered by the first power source; and
b. a second configuration, wherein the light emitting device is connected to the second electrical path for being powered by the second power source.

21. The light fixture as defined in claim 20, wherein the connector element comprises an electrical jumper for being configured into a selected one of the first configuration and the second configuration.

22. The light fixture as defined in claim 21, wherein the connector element comprises an electrical switch for acquiring the selected one of the first configuration and the second configuration.

23. A light system comprising:
a. a first set of light fixtures each comprising a respective light emitting device, each light emitting device being connected to a first power circuit;
b. a second set of light fixtures each comprising a respective light emitting device, each light emitting device being connected to a second power circuit, the first set of light fixtures and the second set of light fixtures being electrically connected in series;
wherein during a first operating condition, electricity is provided to both the first set of light emitting devices and the second set of light emitting devices, and wherein during a second operating condition, electricity is provided only to the second set of light emitting devices.

24. A light system as defined in claim 23, wherein the first power circuit is a normal operation power circuit for a transit vehicle.

25. A light system as defined in claim 24, wherein the second power circuit is an emergency power circuit for a transit vehicle.

26. The light system as defined in claim 23, wherein each of the first set of light fixtures and the second set of light fixtures comprises:
a. a first dimmer path; and
b. a second dimmer path;
wherein the light emitting device of each of the light fixtures in the first set of light fixtures and the second set of light fixtures is in electrical communication with a single one of the first dimmer path and the second dimmer path.

27. The light system as defined in claim 26, wherein control of a dimmer setting at one of the light fixtures in the first set of light fixtures causes control of a dimmer setting in at least one other light fixture of the first set of light fixtures.

28. A light fixture assembly, comprising a plurality of light fixtures, each light fixture comprising:
a. a light emitting device;
b. a first electrical path suitable for connecting the light emitting device to a first power circuit;
c. a second electrical path suitable for connecting the light emitting device to a second power circuit;
d. a connector element for connecting the light emitting device to a selected one of the first electrical path and the second electrical path;
wherein each light fixture is adapted to transfer electricity from the first power circuit and the second power circuit to at least two other light fixtures within the light fixture assembly.

29. A light fixture comprising:
a. a first electrical path for connection to a first electrical circuit, the first electrical path commencing at a first electrical contact and terminating at a second electrical contact;
b. a second electrical path for connection to a second electrical circuit, the second electrical path commencing at a third electrical contact and terminating at a fourth electrical contact;
c. a light emitting device in electrical communication with a single one of the first electrical path and the second electrical path for being powered by a single one of the first electrical circuit and the second electrical circuit.
